(19) United States
(12) Patent Application Publication
(10) Pub. No.: US 2014/0266715 A1
(43) Pub. Date: Sep. 18, 2014

(54) Access Control Systems with Variable Threat Level

(71) Applicant: Honeywell International Inc., (US)

(72) Inventors: Raja Manikandan, Madurai (IN); Sivakumar Balakrishnan, Madurai (IN)

(73) Assignee: Honeywell International Inc., Morristown, NJ (US)

(21) Appl. No.: 13/832,288

(22) Filed: Mar. 15, 2013

(51) Int. Cl. G07C 9/00; G08B 21/02; G08B 7/06

(52) U.S. Cl. CPC G07C 9/00126; G08B 7/06; G08B 21/02
USPC 340/540; 340/5.21

(57) ABSTRACT

A method and apparatus incorporating the method where the method includes the steps of providing an access controller that controls locking devices on entry and egress portals of a secured area, registering the controller with an external website or information source that provides information about public threats existing outside the secured area and modifying an access level for entry into the secured area in response to notice of a public threat received from the external website or information source.

### FIELD

The field of the invention is related to security systems and more particularly to methods of controlling access to secured areas of the security systems.

### BACKGROUND

Security systems are generally known. Such systems typically include one or more sensors of various types used to detect intruders into the secured area and/or one or more security cameras that detect intruders or other threats within the secured area.

In some cases (e.g., a home), access to the secured area may be limited to a small number of authorized persons (e.g., the homeowner and family). In these cases, the security system may be armed when the homeowner leaves home and the security system may operate to signal an alarm to a central monitoring station upon the detection of any person (i.e., intruder) within that area.

In other cases (e.g., an office, factory, etc.), access may be limited a number of authorized persons. In this case, access to the secured area may be provided through one or more designated portals (e.g., doors) and where the opening of any other door may cause the security system to issue an alarm. Access through the designated portals may be controlled through use of a card reader connected to the security system. In this case, the card reader reads an access card carried by authorized users and grants access (unlocks a door) based upon a content of the card.

While existing security systems work well, they are limited in their capacity to protect authorized persons from unanticipated threats associated with the secured area. Accordingly, a need exists for better methods of protecting authorized persons within the secured area.

### BRIEF DESCRIPTION OF THE DRAWING

FIG. 1 is a block diagram of a security system in accordance with an illustrated embodiment.

### DETAILED DESCRIPTION OF AN ILLUSTRATED EMBODIMENT

While embodiments can take many different forms, specific embodiments thereof are shown in the drawings and will be described herein in detail with the understanding that the present disclosure is to be considered as an exemplification of the principles hereof, as well as the best mode of practicing same. No limitation to the specific embodiment illustrated is intended.

FIG. 1 depicts a security system 10 shown generally in accordance with an illustrated embodiment. Included within the security system may be one or more sensors 12, 14 used to protect a secured area 16 from threats. The sensors 12, 14 may be limit switches placed on portals (e.g., doors, windows, etc.) 34 located along the periphery of the secured area and that allow entry to and egress from the secured area.

Alternatively, the sensors may be environmental sensors. In this case, the sensors may serve to detect fires or other hazards within the secured area.

Also included within the secured area may be one or more cameras 18, 20. The cameras may be used to detect security threats both within or along the periphery of the secured area.

The sensors and cameras may be coupled to a control panel 22. Upon activation of a sensor or detection of a threat by one of the cameras, the control panel may send an alarm to a central monitoring station 34. The central monitoring station may summon the police or other help.

Included within the control panel may be one or more processor apparatus (processors) 24, 26 operating under control of one or more computer programs 28, 30 loaded from a non-transitory computer readable medium (memory) 32. As used herein, reference to a step of a computer program is also a reference to the processor that executed that step of the program.

Associated with at least some of the doors 34 located along a periphery of the secured area may be a respective identity sensor (e.g., card reader) 36. In this case, an access processor may monitor the identity sensor for activation by an authorized person and activate a lock 38 to grant entrance into or egress from the secured area.

Under the illustrated embodiment, the system 10 includes provisions to respond to external threats. In this regard, the system may register itself to receive notices of alarms raised in the neighborhood of the secured area. This includes registering with websites that raise alarms based upon status of public safety organizations, registering with alarm stations that provide panic alarms of imminent public threat or government agencies that provide the locations of blacklisted people. In addition, options may be provided in registering for receipt of notices via TCP/IP or by the hardwiring of external devices. The alerts received will contain the type of alarm, the sensitivity and priority associated with the alarm, the source generating the alarm, the time at which the alarm was triggered and associated text data along with it. The types of alarms that the system may receive include neighborhood riots, natural calamities (e.g., rain, storm, etc.), neighborhood fire, and presence of a black listed person, sex offender or a terrorist in the neighborhood.

Based upon the notice or alert received and its severity, the system will decide upon the corresponding actions. These actions include opening/closing all doors in the system, securing the perimeter of the building to deny illegal entry into the building, selective opening/closing of certain doors in a floor or entity, sending out commands to other security devices installed in the premises. The actions may also include relaying a panic alarm to other external systems which are interested in such alarms via mass event notification systems.

The severity of the alarm determines the duration during which the security system modifies its operational state in response to the threat. The higher the severity of the alarm notice, the longer the operational state is modified.

Provisions are provided in the system to over-ride the threat level modification of the operational state, manually. In this regard, an authorized user may employ a user interface 40 to implement the modification of the operational state of the security system. The user interface may be included on the control panel or located remotely from the control panel.

The user interface may include a display 42. The display may be touch sensitive or the user interface may include a separate keyboard 44 through which the user may enter instructions.

In order to modify operation of the security system in response to the external threat, the user may activate a browser associated with the user interface to browse for and select one or more websites 52 of public safety organizations 46 through the Internet 48. The website may provide a list of public threats that is updated in real time based upon the detection and occurrence of those events. Each of those events posted to the list may include an identifier of the type of event, a time of the event and geographic indicia (e.g., GPS coordinates) of the location of the event.

The events may each also contain an indicator of the threat level of the event. The indication of the threat level may be based upon an objective indicator, such as the likelihood of the event or the potential for loss of life upon the occurrence of the event.

Alternatively, the threat level may be based upon other factors. For example, in the case of a sex offender, the threat level may be based upon a geographical distance of the domicile of the sex offender to the secured area. In the case of a natural gas leak, the threat level may be based upon the size of the leak and the geographical distance of the detected location of the gas leak to the secured area. Similarly if the threat is the detection of a pathogen (e.g., anthrax, small pox, etc.) released by a terrorist, the threat level may also be based upon a geographical distance of the detected location of the location of the discharge and/or probable location of the terrorist to the secured area.

A processor of the security system may also modify the threat level received as part of the notice or substitute its own threat level based upon distance. In this case, a threat processor may compare the geographic coordinates of the threat with the geographic coordinates of the secured area and adjust the threat level accordingly.

The user may elect to receive notices including the entire list and real time updates to the list or the user may select to receive real time notices of specific types of threats. As each notice is received, it may be saved in a file 54 that includes all events or the user may select a particular file 54, 56 for each type of event.

In addition to receiving notices from public safety organizations, the security system may include one or more wired connections to external sensors or data sources 50. The sensors may be maintained outside the periphery of the secured area and/or may be maintained by independent monitoring organizations. In each case, real time notices of threats are saved in files 54, 56.

The user may also save his/her own indicator of threat level for each type of notice in the file 54, 56 that is independent of the threat level assigned by the public safety organization. For example, if the secured area is a school or day care center, then the user may save a threat level that is very high for sex offenders. In this case, the threat level assigned by the user would be used in place of the threat level provided by the public safety organization.

One or more threat processors may retrieve the various threats saved in the files 54, 56 and modify operation of the security system accordingly. For example, in the case of a sex offender or terrorist, the processor may modify the access level for entry into the secured area in response to the notice by automatically activating one or more (or all) of the locks 38 to lock each of the doors providing entry into the secured area.

Alternatively, the threat processor may activate the locks 38 to open each of the doors 34 to allow easy access by police or rescue workers. This may be the case in the event of a gas leak or fire near a protected area that includes a school.

In addition, a notification processor operating in conjunction with the threat processor may automatically notify authorized occupants of the secured area of the type and scope of the threat. In this case, the notification processor may cause one or more audible or visual notices to be presented to the occupants through one or more speakers or visual displays within the secured area.

The scope of modification of operation of the security system and time of modification may be based upon the threat level provided by the user and/or public service organization. For example, in the event of a sex offender or terrorist directly outside the secured area, all doors may be immediately locked.

Similarly, the time of modification of the security system is based upon the scope of threat. The time during which the security system is modified is response to the threat may be based upon a number of different respective time values saved in the files 54, 56 where each time value is based upon a specific threat and threat level. Each time a new notice of a threat is received, the security system may be modified by the corresponding predetermined time associated with the threat and threat level. In the case, where the threat is a continuing situation, then the predetermined time may be extended or the processor that compares the accumulated time since notification of the threat with the predetermined time period may be reset the accumulating time each time a new notification of the threat is received.

In some cases, the authorized user may wish to modify or cancel the modification of the security system caused by the notification. For example, in the case of a school, the user may cancel the modification at the end of the school day when it becomes necessary to open the doors in order to allow the children to go home. The user may implement this change through a cancel button displayed on the user interface.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims.

1. A method comprising:
providing an access controller that controls locking devices on entry and egress portals of a secured area;
registering the controller with an external website or information source that provides information about public threats existing outside the secured area; and
modifying an access level for entry into the secured area in response to notice of a public threat received from the external website or information source.

2. The method as in claim 1 wherein the notice of public threat further comprises notice of a riot, black listed person, sex offender or terrorist in the environ of the secured area.

3. The method as in claim 2 wherein the modification further comprises automatically locking at least some entry portals of the secure area based upon a threat level associated with the notice.

4. The method as in claim 1 wherein the notice of public threat further comprises notice of a gas leak or fire in the environ of the secured area.

5. The method as in claim 4 wherein the modification further comprises automatically unlocking at least some entry portals of the secured area to allow evacuation by public safety personnel of authorized persons within the secured area.

6. The method as in claim 1 further comprising automatically issuing an audible or visual alert to authorized occupants of the secured area based upon a threat level associated with the notice.

7. The method as in claim 6 wherein the audible or visual alert further comprises an evacuation announcement.

8. The method as in claim 1 further comprising canceling the modification of the access level after a predetermined time period following receipt of the notice.

9. The method as in claim 8 further comprising setting the predetermined time period for cancellation based upon a threat level of the notice.

10. The method as in claim 1 further comprising receiving an input from an authorized user that cancels the modification of the access level.

11. An apparatus comprising:
an access controller that controls locking devices on entry and egress portals of a secured area;
an interface of the controller that registers with an external website or information source that provides information about public threats existing outside the secured area; and
a processor that modifies an access level for entry into the secured area in response to notice of a public threat received from the external website or information source.

12. The apparatus as in claim 11 wherein the notice of public threat further comprises notice of a riot, black listed person, sex offender or terrorist in the environ of the secured area.

13. The apparatus as in claim 12 wherein the modification further comprises a processor that automatically locks at least some entry portals of the secure area based upon a threat level associated with the notice.

14. The apparatus as in claim 11 wherein the notice of public threat further comprises notice of a gas leak or fire in the environ of the secured area.

15. The apparatus as in claim 14 wherein the modification further comprises a processor that automatically unlocks at least some entry portals of the secured area to allow evacuation by public safety personnel of authorized persons within the secured area.

16. The apparatus as in claim 11 further comprising a processor that automatically issues an audible or visual alert to authorized occupants of the secured area based upon a threat level associated with the notice.

17. The apparatus as in claim 16 wherein the audible or visual alert further comprises an evacuation announcement.

18. The apparatus as in claim 11 further comprising a processor that automatically cancels the modification of the access level after a predetermined time period following receipt of the notice.

19. An apparatus comprising:
a security system having a secured area;
an access controller of the security system that controls locking devices on entry and egress portals of the secured area;
an interface of the controller that registers with an external website or information source that provides information about public threats existing outside the secured area; and
a processor that modifies an access level for entry into the secured area in response to notice of a public threat received from the external website or information source.

20. The apparatus as in claim 19 further comprising a notification processor that notifies occupants of the secured area about the threat.
